(19) United States
(12) Patent Application Publication
(10) Pub. No.: US 2014/0306647 A1
(43) Pub. Date: Oct. 16, 2014

(54) CHARGING DEVICE FOR VEHICLE

(71) Applicant: HON HAI PRECISION INDUSTRY CO., LTD., New Taipei (TW)

(72) Inventors: KUANG-YAO LIAO, New Taipei (TW); CHIA-CHING WU, New Taipei (TW); CHIH-CHUNG WENG, New Taipei (TW)

(73) Assignee: HON HAI PRECISION INDUSTRY CO., LTD., New Taipei (TW)

(21) Appl. No.: 14/224,676

(22) Filed: Mar. 25, 2014

(30) Foreign Application Priority Data
Apr. 12, 2013 (TW) 102112951

(51) Int. Cl. H02J 7/00

(52) U.S. Cl. CPC H02J 7/0052
USPC 320/107

(57) ABSTRACT

A charging device for an electronic device in a vehicle includes a charging plug, a charging connector, a coupling wire assembly, and a signal reception assembly. The charging plug includes a power supply module and a signal transceiver electrically coupled to the power supply module. The charging connector includes a connection member for coupling the electronic device and an induction antenna positioned adjacent to the connection member. The coupling wire assembly includes an electric wire and a first transmission antenna. The electric wire is coupled to the power supply module and the connecting member, and the first transmission antenna is coupled to the signal transceiver and the induction antenna. The signal reception assembly includes a signal reception base positioned on an outer portion of the vehicle and a second transmission antenna coupling with the signal reception. The signal reception base includes a reception antenna.

### FIELD

The present disclosure generally relates to charging devices, and particularly to a charging device for electronic devices in a vehicle.

### BACKGROUND

Electronic devices, such as a wireless GPS automotive navigation device positioned in a vehicle for navigation, can be used in a vehicle. A charging device is inserted in a lighter socket of the vehicle and is electrically coupled with the electronic device for charging. However, the signal reception of electronic devices can be impeded by the vehicle's glass windows and the vehicle's body generally.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a view of one embodiment of a charging device including a charging connector in a vehicle.

FIG. 2 is a top view of the charging connector of the charging connector of FIG. 1.

FIG. 3 is a side view of the charging connector of the charging connector of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as connected, whether directly or indirectly through intervening components, and is not necessarily limited to physical connections. The connection can be such that the objects are permanently connected or releasably connected.

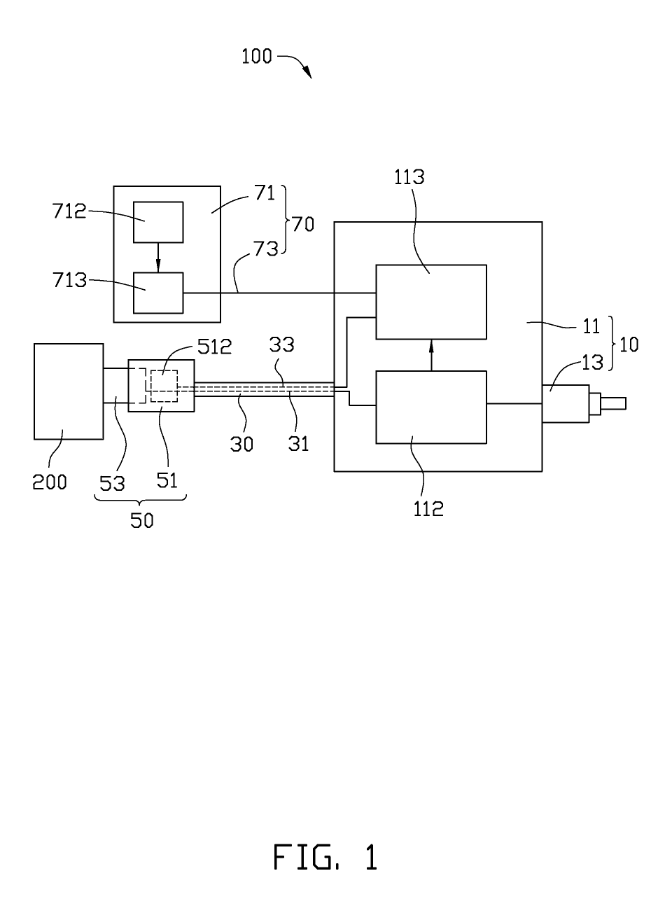

FIG. 1 shows a charging device 100, which is configured for use in a vehicle (not shown), for charging and transmitting a signal to an electronic device 200. In the illustrated embodiment, the electronic device 200 can be an automatic navigation device, and the signal can be global positioning signal (GPS) from GPS satellites. The charging device 100 can include a charging plug 10, a coupling wire assembly 30, a charging connector 50, and a signal reception assembly 70. In other embodiments, the electronic device 200 can be a mobile phone, or an E-book reader.

The charging plug 10 can include a main body 11 and an inserting member 13 coupled with the main body 11. A power supply module 112 and a signal transceiver 113 can be positioned within in the main body 11. The power supply module 112 can be electrically coupled to the signal transceiver 113 for supplying power to the signal transceiver 113. The inserting member 13 can be mounted on and can protrud from the main body 11. The inserting member 13 can be electrically coupled to the power supply module 112. The inserting member 13 can be coupled with a lighter socket (not shown) of the vehicle for obtaining electric power from the lighter socket and transmitting the electric power to the signal transceiver 113.

The coupling wire assembly 30 can include an electric wire 31 and a first transmission antenna 33. The power supply module 112 can be electrically coupled with a first end of the electric wire 31, and the charging connector 50 can be electrically coupled with a second end of the electric wire 31 for transmitting power from the power supply module 112 to the charging connector 50. The first transmission antenna 33 can be electrically coupled with the signal transceiver 113 at one end, and can be electrically coupled with the charging connector 50 at another end for transmitting the signal from the signal transceiver 113 to the charging connector 50.

The charging connector 50 can be coupled with a connector of the electronic device 200, such as a universal serial bus (USB) connector. The charging connector 50 can include a base body 51 and a connection member 53. A portion of the electric wire 31 can be positioned in the base body 51. An induction antenna 512 can be positioned in the base body 51. In the illustrated embodiment, the induction antenna 512 can be coupled with the first transmission antenna 33 and can be positioned adjacent to the connection member 53 for transmitting the signal to the electronic device 200. The connection member 53 can be positioned on and protrudes from the base body 51 for inserting the connector of the electronic device 200. The connection member 53 can be electrically coupled with the electric wire 31 for supplying power to the electronic device 200. In other embodiments, the connection member 53 can be coupled with the induction wire 512 via a coupled capacitor (not shown), and the signal can be transmitted to the electronic device 200 via the connection member 53 when the connection member 53 can be coupled to the connector of the electronic device 200 for charging. The signal can be directly transmitted to the electronic device 200 by the induction antenna 512 when the connection member 53 is not coupled with the connector of the electronic device 200.

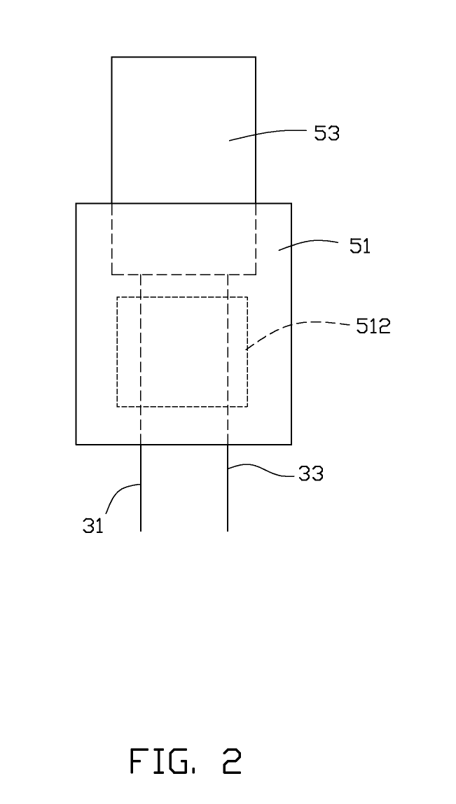

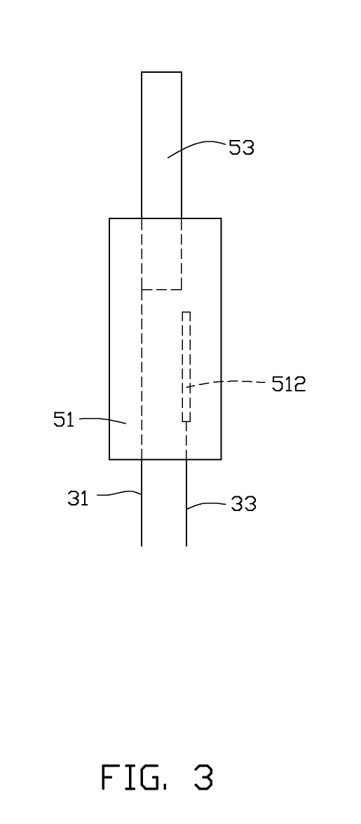

FIGS. 2 and 3 show that the signal reception assembly 70 can be positioned on an outer portion of the vehicle and coupled with the charging plug 10. The signal reception assembly 70 can include a signal reception base 71 and a second transmission antenna 73 coupled with the signal reception base 71. The signal reception base 71 can be positioned on the outer portion of the vehicle for receiving the signal. A reception antenna 712 for receiving signal and a signal amplification module 713 can be positioned in the signal reception base 71. The signal amplification module 713 can be coupled with the reception antenna 712 for amplifying the signal received by the reception antenna 712. The second transmission antenna 73 can be coupled with the signal amplification module 713 and the signal transceiver 113. Thereby, the signal received by the reception antenna 712 can be amplified by the signal amplification module 713 and can be transmitted to the signal transceiver 113.

In use, the signal reception assembly 70 can be mounted on the outer portion of the vehicle, and the second transmission antenna 73 is coupled with the signal amplification module 713 and the signal transceiver 113. The inserting member 13 can be inserted in the lighter socket within the vehicle. The electrical power can be transmitted to the power supply module 112 and the signal transceiver 113. The signal can be amplified by the signal amplification module 713 and can be transmitted to the signal transceiver 113 via the first transmission antenna 33 and the induction antenna 512. The electrical power can be supplied to the electronic device 200 when the connection member 53 is coupled with the electronic device 200 for charging, and the signal can be transmitted to the electronic device 200. The signal transmitted by the first transmission antenna 33 can be transmitted to the electronic device 200 via the first transmission antenna 33 and the induction antenna 512, when the electronic device 200 is detached from the connection member 53.

As described above, the signal reception base 71 of the signal reception assembly 70 can be positioned on the outer portion of the vehicle and can be coupled with the signal transceiver 113 via the second transmission antenna 73. Thereby, the signal received by the signal reception assembly 70 can be transmitted to the electronic device 200 via the second transmission antenna 73, the signal transceiver 113, the coupling wire assembly 30, and the induction antenna 512, and can react against influence window glasses of the vehicle.

In other embodiments, the signal amplification module 713 can be omitted, and the receiving antenna 712 can be directly coupled with the first transmission antenna 33.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A charging device for an electronic device in a vehicle, comprising:
a charging plug comprising a power supply module and a signal transceiver electrically coupled to the power supply module;
a charging connector comprising a connection member for coupling the electronic device and an induction antenna positioned adjacent to the connection member;
a coupling wire assembly comprising an electric wire and a first transmission antenna, the electric wire coupled with the power supply module and the connecting member for supplying electric power to the electronic device, and the first transmission antenna coupled to the signal transceiver and the induction antenna;
a signal reception assembly comprising a signal reception base positioned on an outer portion of the vehicle and a second transmission antenna coupled to the signal reception assembly, wherein the signal reception base comprises a reception antenna, the second transmission antenna is coupled with the reception antenna and the signal transceiver, a signal received by the reception antenna is transmitted to the electronic device via the second transmission antenna, the first transmission antenna, and the induction antenna; and the signal is transmitted to the electronic device via the induction antenna when the connection member is coupled to the electronic device for charging.

2. The charging device of claim 1, wherein the signal reception base further comprises a signal amplification module coupled to the reception antenna for amplifying the signal received by the reception antenna and transmitting thereof to the signal transceiver.

3. The charging device of claim 1, wherein the charging connector further comprises a base body, and the induction antenna is positioned within the base body, both the electric wire and the first transmission antenna are coupled with the base body, and the connection member is mounted on and protruding from the base body, and the connection member is coupled with the electric wire.

4. The charging device of claim 1, wherein the charging plug further comprises a main body and an inserting member coupled to the main body, the power supply module and the signal transceiver are positioned within in the main body.

5. The charging device of claim 1, wherein the inserting member is mounted on and protrudes from the main body, and the inserting member is electrically coupled to the power supply module.
